(19) United States
(12) Patent Application Publication
(10) Pub. No.: US 2012/0052470 A1
(43) Pub. Date: Mar. 1, 2012

(54) CPR DUMMY WITH AN ACTIVE MECHANICAL LOAD

(75) Inventors: Pierre Hermanus Woerlee, Eindhoven (NL); Igor Wilhelmus Franciscus Paulussen, Eindhoven (NL); Frank Titus Marie Jaartsveld, Eindhoven (NL)

(73) Assignee: KONINKLIJKE PHILIPS ELECTRONICS N.V., Eindhoven (NL)

(21) Appl. No.: 13/320,222

(22) PCT Filed: Apr. 29, 2010
(86) PCT No.: PCT/IB10/51873

§ 371 Date: Nov. 11, 2011

(30) Foreign Application Priority Data
May 11, 2009 (EP) 09159882.1

(51) Int. Cl. G09B 23/28

(52) U.S. Cl. 434/265

(57) ABSTRACT

A cardiopulmonary resuscitation (CPR) simulation load capable of simulating a reactive force of a patient's chest upon chest depression, the cardiopulmonary resuscitation simulation load comprising an active actuator (M) arranged to generate at least part of the reactive force, and a controller (CTRL) arranged to provide a control signal to the active actuator. A CPR simulation manikin comprising such a CPR simulation load is also proposed. Furthermore, a method for simulating a reactive force of a patient's chest during cardiopulmonary resuscitation by means of a simulation manikin, the method comprising: measuring a depression of a simulation manikin chest; calculating a resulting reactive force depending on the measured depression of the simulation manikin chest; applying the resulting reactive force to the patient's chest by means of an active actuator. With an active actuator the simulated reactive force may be more easily adjusted and the non-linear behavior of a true patient's chest can be accurately modeled.

### FIELD OF THE INVENTION

The invention relates to the field of a mechanical load capable of simulating a reactive force of a patient chest upon chest depression. Such mechanical loads can be used for cardiopulmonary resuscitation simulation during cardiopulmonary resuscitation training or during testing automated devices for cardiopulmonary resuscitation. More particularly, the present invention relates to a cardiopulmonary resuscitation simulation load, to a cardiopulmonary resuscitation simulation manikin, and to a method for simulating a reactive force of a patient chest during cardiopulmonary resuscitation.

### BACKGROUND OF THE INVENTION

Cardiopulmonary resuscitation (CPR) is a task that requires skill and routine in order to be efficient and safe. Medical practitioners and health care professionals are expected to perform CPR according to the standard and guidelines and need to be trained in an appropriate manner. Besides the knowledge about the correct order of the actions that need to be performed, the compressions of the patient's chest that the CPR administering person performs have to be of a certain strength, compression depth, and velocity. If the compressions are too weak, too shallow, or too slow, resuscitation might not be successful or take a long time. If on the other hand the compressions are too strong or too deep, the rib cage or other parts of the body of the patient may become damaged.

Besides manual administration of CPR, automated CPR devices have become more and more popular, especially in intensive care units and for long-term resuscitation. Realistic testing of new devices for Cardio Pulmonary Resuscitation requires that the test load mimics the mechanics of the human thorax very well. Unfortunately the mechanical properties of the human thorax are complex and highly non-linear. Moreover, there is a very large person-to-person variation in the mechanical properties of the human thorax. Hence it is difficult to design test loads that mimic the human thorax.

The visco-elastic model of the human thorax can be approximated by a parallel combination of elastic and damping elements. Both the elastic and damping terms increase strongly in magnitude when chest compression depth increases.

Current CPR test devices and training manikins have mechanical loads that deviate strongly from that of the human thorax. A simple linear spring like structure is used in most cases, the damping device is often absent. Such simple loads overestimate the stiffness for small compression depth and damping and friction are neglected.

US patent application 2007/02646231 from Laerdal discloses a CPR training manikin for simulating realistic conditions. The CPR training manikin has a first part for receiving applied pressure and movement from the user and a second part for positioning on a supporting surface. The first and second parts are separated by an elastic element and guiding means for providing an essentially linear movement between the parts. The training manikin also comprises a piston containing a fluid providing a dampened movement between the parts in the direction of the linear movement. Thus the Laerdal patent application proposes a solution of pure passive non-linear mechanical devices.

U.S. Pat. No. 4,601,665 to Messmore and U.S. Pat. No. 5,509,810 to Schertz et al. describe a training manikin for educational purposes such as teaching medical students, health care professionals, etc. These training manikins are designed to simulate typical symptoms of a disease, such as noises and vibrations of the body. The task of the medical students is to detect the symptoms, to analyze the symptoms, and to conclude which disease the patient may be suffering of Thus, a medical student can train his skills in making a medical diagnosis, taking into account all the symptoms he sees, hears, or feels. The training manikins described in U.S. Pat. No. 4,601,665 and U.S. Pat. No. 5,509,810 cannot produce a realistic reactive force and are not suited as CPR training manikins.

### SUMMARY OF THE INVENTION

It would be desirable to provide a versatile cardiopulmonary resuscitation simulation load that is capable of mimicking a wide range of loads as they occur with patients with different physique or during longer lasting cardiopulmonary resuscitation. It would also be desirable that the cardiopulmonary resuscitation simulation load is capable of simulating the complex and highly non-linear mechanical properties of the human thorax in a sufficiently accurate manner. It would also be desirable to enable a cardiopulmonary resuscitation simulation load of accurately representing the elastic and/or damping parts of a human thorax bio-mechanical model. To better address one or more of these concerns a cardiopulmonary resuscitation simulation load is proposed. The cardiopulmonary resuscitation simulation load, or cardiopulmonary resuscitation simulation load device, is capable of simulating a reactive force of a patient chest upon chest depression (chest displacement). The cardiopulmonary resuscitation simulation load comprises an active actuator arranged to generate at least a part of the reactive force and a controller arranged to provide a control signal to the active actuator. An active actuator can easily be controlled in a flexible and variable manner. The control signal issued by the controller causes the active actuator to generate a reactive force having a particular strength. From the discussion of the simulation manikins currently available it is clear that an accurate non-linear mechanical load is needed. It is difficult to obtain such a load with passive devices only. Moreover, the large variation in victim properties requires that a wide range in stiffness and damping properties is needed. This would require a large number of passive loads.

The active actuator may be an electro mechanical actuator, a pneumatic actuator, or hydraulic actuator.

It would be desirable to provide a cardiopulmonary resuscitation simulation load wherein the active actuator has a reasonable size and/or power rating. In an embodiment this concern is addressed by the cardiopulmonary resuscitation simulation load further comprising a passive mechanical component arranged to generate at least another part of the reactive force. The contributions of the active actuator, the passive mechanical component, and possibly some other element(s) add up to the total reactive force. Due to the passive mechanical component bearing part of the reactive force, the active actuator may be sized smaller than in the case where the active actuator would have to generate the entire reactive force by itself. In the case of a combination of an active actuator and passive mechanical component the passive mechanical component might contribute a part of the reactive force that has a substantially linear dependency from the current chest depression and/or the current depression velocity. The active actuator might contribute the deviations from the linear characteristic. Depending on the structure of the cardiopulmonary resuscitation simulation load and the scenario to be simulated the contribution of the active actuator might even be negative, i.e. at least partly counter-acting the contribution of the passive mechanical component.

It would be further desirable to provide a cardiopulmonary resuscitation simulation load for which the reactive force can be controlled as a function of the chest depression. In an embodiment this concern is addressed by the cardiopulmonary resuscitation simulation load further comprising a chest depression sensor, or chest displacement sensor, arranged to provide a chest depression measurement to the controller.

It would be further desirable that the determination of the reactive force takes into account an instantaneous measurement of the chest depression. In an embodiment this concern is addressed by the cardiopulmonary resuscitation simulation load further comprising a reaction force calculator arranged to calculate the part of the reactive force to be generated by the active actuator as function of the chest depression measurement.

It would be desirable that the reaction force calculator is capable of reproducing the mechanical behavior of a human chest. In an embodiment this concern is addressed by the reaction force calculator being model based or based on an empirical relation.

The reaction force calculator may be arranged to calculate at least one of an elastic term, a damping term, or an inertial term. The elastic term may be used to calculate the mechanical behavior of a spring. The damping term may be used to calculate the mechanical behavior of a damping element, such as a shock absorber. The inertial term may be used to calculate the mechanical behavior of a mass. Elastic behavior, damping behavior and inertial behavior are useful for describing the overall mechanical behavior of a mechanical system. Specific values and formulas for the elastic term, the damping term, and the inertial term are available in the literature, for example in Gruber et al. Journal of Biomech. Eng., May 1993, vol. 115, pp 14-20. Using these terms for calculating the reactive force adds to the inter-changeability and comparability of parameters used and produced by the cardiopulmonary resuscitation simulation load.

It would be further desirable to enable the cardiopulmonary resuscitation simulation load to mimic a varying mechanical behavior of a patient's chest during longer-lasting resuscitation. In an embodiment this concern is addressed by the cardiopulmonary resuscitation simulation load further comprising a parameter adjuster acting on the reaction force calculator by varying parameters used to calculate the part of the reactive force to be generated by the active actuator. When administering cardiopulmonary resuscitation for a longer time, a change of the mechanical behavior of the patient chest can be observed. This behavior can be simulated by varying the parameters that are used to calculate the reactive force, or a part thereof over the duration of the cardiopulmonary resuscitation. The parameter adjuster may detect the start of a cardiopulmonary resuscitation session and count the strokes or measure the elapsed time. Based on these measurements the parameter adjuster may adjust the parameters so as to closely reproduce the changing mechanical behavior of an actual human chest during CPR. To this end, the parameter adjuster may have access to a Look-up table or to a memory storing typical values for the mechanical properties of a range of individuals or mathematical relations representative of the time-varying mechanical behavior.

It would be also desirable that a single device is capable of mimicking a wide range of loads. In an embodiment this concern is addressed by the reaction force calculator being software controlled. Using software, it is relatively easy to change single parameters or to select one model along a set of stored models, such as infant, adolescent, male adult, female adult.

It would be desirable that the cardiopulmonary resuscitation simulation load is compact in size and capable of being powered by means of a battery. In an embodiment this concern is addressed by the active actuator being a DC rotation motor. A DC rotation motor is controllable by adjusting the voltage and/or the current supplied to the motor. This can be achieved using simple circuitry. A DC rotation motor requires DC voltage, such as the voltage supplied by a battery.

It would be further desirable that the cardiopulmonary resuscitation simulation load is capable of producing a reactive force sufficiently strong to simulate the reactive force of an actual patient chest. In an embodiment this concern is addressed by the cardiopulmonary resuscitation simulation load further comprising a pinion and rack construction arranged to convert a rotary movement of e.g. a DC rotation motor into a linear movement of the artificial chest. With a pinion and rack construction two goals may be achieved, if desired: The conversion of a rotary movement into a linear movement and a gear reduction resulting in a strong output force at the rack and of the pinion and rack construction. However, it is not necessary that these goals are achieved.

It would be desirable that the reactive force approximates the absolute value of the applied force. In an embodiment this concern is addressed by the cardiopulmonary resuscitation simulation load further comprising a force sensor arranged to provide a force measurement to the controller for providing server control for the active actuator based on a force control loop. The force control loop assures that the cardiopulmonary resuscitation simulation load produces a true reactive force that reacts to the force applied by a user.

It would be desirable to provide information during or after the cardiopulmonary resuscitation process to the user for training purposes or for testing/tuning an automated cardiopulmonary resuscitation device. In an embodiment this concern is addressed by the cardiopulmonary resuscitation simulation load further comprising a feedback interface for providing feedback to a user. The feedback interface may be a display, a speech output, a tactile feedback such as vibration of the artificial chest, or the like. The user maybe informed about the quality of his or her cardiopulmonary resuscitation via the feedback interface. The feedback to the user may also comprise instructions such as “push stronger”, “push weaker”, “push deeper”, “push faster”, and the like. To this end, the cardiopulmonary resuscitation simulation load would comprise a memory with typical guidelines for cardiopulmonary resuscitation stored there on. It would further comprise detectors for various parameters indicative of the cardiopulmonary resuscitation. Furthermore, the cardiopulmonary resuscitation simulation load could comprise comparators for comparing the parameters suggested by the guidelines with the actual parameters. The output of the comparators could then be something like “too low”, “optimal”, “too high”.

It would be desirable to make the experience of cardiopulmonary resuscitation training as realistic as possible. In order to address this concern or possibly other concerns a cardiopulmonary resuscitation simulation manikin is proposed that comprises a cardiopulmonary resuscitation simulation load as described above in one of the embodiments. A cardiopulmonary resuscitation simulation manikin simulates the look-and-feel of an actual patient. Such a manikin usually features a torso-like housing having a surface that imitates the human skin. The cardiopulmonary resuscitation simulation load may be enclosed within the housing. The housing is at least partly flexible and deformable in order to allow a user to depress the chest of the manikin.

Beside the cardiopulmonary resuscitation simulation load and the cardiopulmonary resuscitation simulation manikin described above, it would be desirable to achieve a method for simulating a reactive force of a patient chest during cardiopulmonary resuscitation by means of a simulation manikin. It would also be desirable that the method is capable of mimicking the complex and highly non-linear mechanical behavior of an actual human chest. Furthermore it would be desirable that the method can be used to simulate a wide range of loads. To better address one or more of these or other concerns a method for simulating a reactive force of a patient chest during cardiopulmonary resuscitation by means of a simulation manikin is presented. The method comprises:

measuring a depression of a simulation manikin chest”,

calculating a resulting reactive force depending on the measure depression of the simulation manikin chest”,

applying the resulting reactive force to the simulation manikin chest by means of an active actuator.

The different technical features can be arbitrarily combined and such combination is herewith disclosed. In particular, but not exclusively, cardiopulmonary resuscitation simulation load may comprise any combination of the following: an active actuator, a controller, an electro mechanical actuator, a pneumatic actuator, a hydraulic actuator, a passive mechanical component, a chest depression sinter, a reaction force calculator (model based, based on an empirical relation, or based on other relations), a reaction force calculator arranged to calculate at least one of an elastic term, a damping term, or an inertial term, a parameter adjuster, a software controlled reaction force calculator, a DC rotation motor, a pinion and rack construction, a force sensor, and a feedback interface. In relation to a method for simulating a reactive force of a patient chest during cardiopulmonary resuscitation any combinations of the actions described above is possible and herewith disclosed. In particular, but not exclusively, two or more of the following actions can be combined:

measuring a depression of a simulation manikin chest;

calculating a resulting reactive force depending on the measured depression of the simulation manikin chest;

applying the resulting reactive force to the patient chest by means of an active actuator;

generating the reactive force electromechanically, pneumatically, or hydraulically;

generating another part of the reactive force by means of a passive mechanical component;

calculating the resulting reactive force or a part thereof by means of a model or based on an empirical relation;

calculating at least one of an elastic term, a damping term, or an inertial term;

varying parameters used to calculate the part of the reactive force generated by the active actuator by means of a parameter adjuster acting on the reaction force calculator;

controlling the reaction force calculator by means of software;

using a DC rotation motor as part of the active actuator;

using a pinion and rack construction;

providing a force measurement to the controller for providing server control for the active actuator based on a force control loop;

providing feedback to a user.

The various embodiment may achieve one or more of the following:

accurate representation of elastic part of human thorax bio-mechanical model;

accurate representation of damping part of human thorax bio-mechanical model,

due to server and software control a single device is capable to mimic a wide range of loads;

due to servo and software control the properties of the load can be arranged to vary during a test/simulation/training (as occurs in practice);

size sufficiently small to fit in the chest of a CPR manikin;

the device is based on a model, so easy to adapt if new models/data become available;

cost can be sufficiently low;

Possibility for feedback to the user (training)

These and other aspects of the invention will be apparent from and illustrated with reference to the embodiment(s) described herein after.

### BRIEF DESCRIPTION OF THE DRAWINGS

FIG. 1 shows a schematic cross section through a cardiopulmonary resuscitation simulation manikin and a simulation load as proposed by the teachings disclosed herein.

FIG. 2 shows a schematic block diagram of a cardiopulmonary resuscitation simulation load as proposed by the teachings disclosed herein.

FIG. 3 shows a perspective view of mechanical and electrical components of a CPR simulation load according to the teachings disclosed herein.

FIG. 4 shows a schematic block diagram of the control chain of a CPR simulation load according to the teachings disclosed herein.

FIG. 5 shows a flowchart of a method for simulating a reactive force according to the teachings disclosed herein.

FIG. 6 shows a relation between the depression depth of the artificial chest and the reactive forces produced by a passive mechanical component and an active actuator, as well as the total reactive force.

FIG. 7 shows another relation between the depression depth of the artificial chest and the reactive forces produced by a passive mechanical component and an active actuator, as well as the total reactive force.

### DETAILED DESCRIPTION OF THE EMBODIMENTS

From the introduction it is clear that an accurate non-linear mechanical load is needed, moreover it is extremely difficult to obtain such a load with passive devices only. The large variation in victim properties requires a large number of passive loads. This is not practical and the preferred solution is to have a single active device.

Unlike the previous devices, a mechanical load containing an active and servo-controlled element is proposed and described in more detail below.

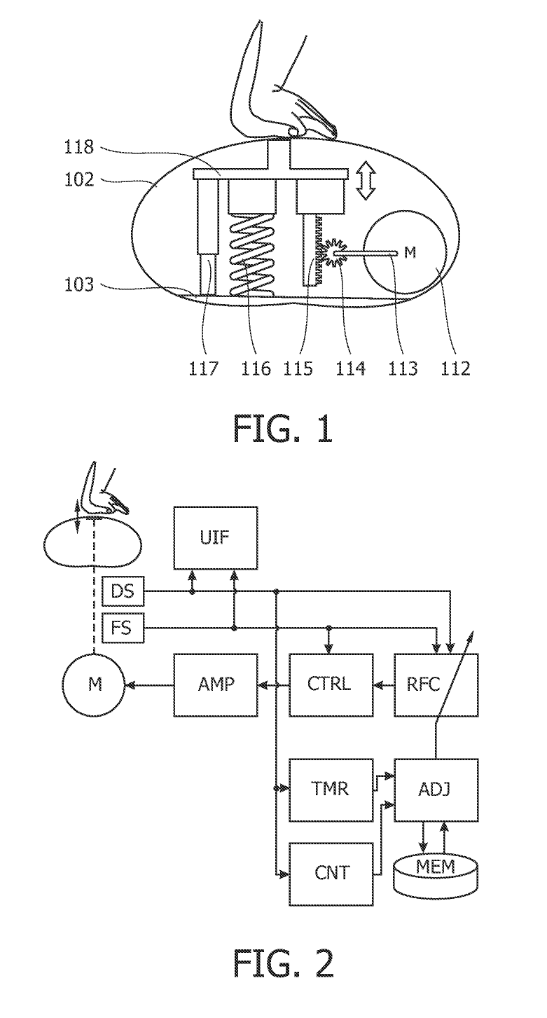

FIG. 1 shows a schematic cross section of a CPR simulation manikin and an embedded CPR simulation load according to the teachings disclosed herein. The CPR simulation manikin may be used to train how to administer CPR to medical practitioners, medical students, health care professionals, or lay persons.

Another application of CPR simulation manikin might be calibration and/or testing of automated CPR devices. In FIG. 1 the person administering the simulated CPR exerts a downward force on the upper surface of the CPR simulation manikin in a periodical manner, e.g. thirty strokes in about twenty seconds. The CPR simulation manikin shown in FIG. 1 comprises a housing 102 and a ground plate 103. The upper surface of the CPR simulation manikin is deformable so that the CPR administering person can depress the upper surface. Within the CPR simulation manikin this movement is transferred to a mechanical arrangement, in the case of FIG. 1 a beam 118 for distributing the force to three mechanical components. The left-most of the three mechanical components is a damper 117, for example in the form of a cylinder-piston arrangement or a double cylinder arrangement. A damper produces a reactive force that is mainly a function of the velocity by which it is depressed. The second of the mechanical components is a spring 116 or a similar elastic element. A spring produces a reactive force that is mainly a function of the compression depth. The right most of the mechanical components is an active actuator comprising an electrical motor 112, a transmission element 113, a pinion 114, and a rack 115. The electrical motor 112 produces a torque that is transmitted via transmission element 113 to the pinion 114. The pinion 114 engages the rack 115 to form a pinion and rack construction. The pinion and rack construction converts the rotary movement of the electrical motor 112 into a linear movement. In a similar manner, the torque produced by the electrical motor 112 is convertible to a linear force. The reactive forces of damper 117, spring 116 and active actuator 112, 113, 114, 115 are transmitted to the beam 118 where they are combined and transmitted to the CPR administering person as a feedback force. The combination of passive components (damper 117 and spring 116) and active components (active actuator 112, 113, 114, 115) makes it possible to generate a reactive force of the required strength (about 1000 N), while keeping the active actuator relatively small. The active actuator makes it possible to control the reactive force in a flexible manner.

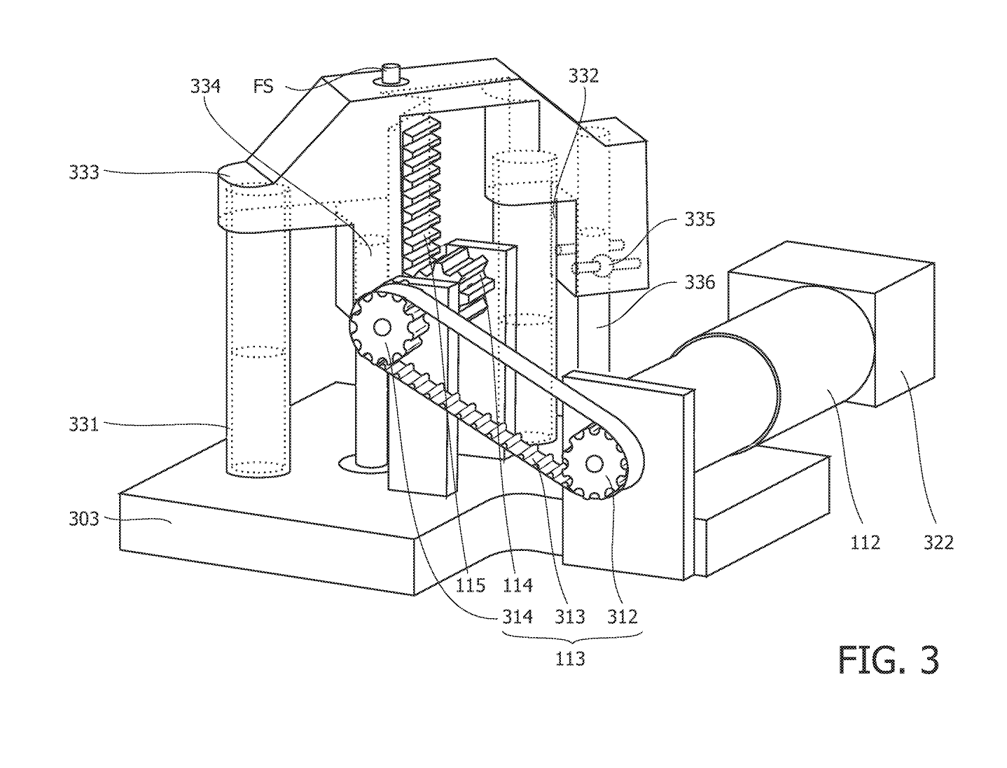

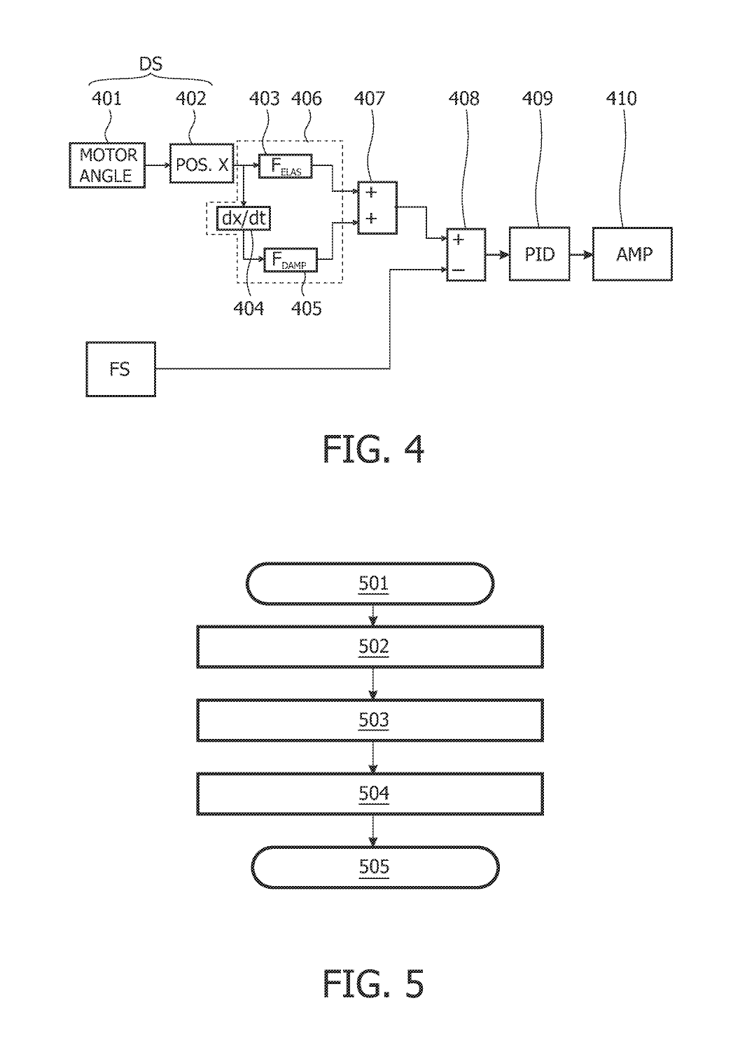

FIG. 2 shows a schematic block diagram of the CPR simulation load according to the teachings disclosed herein. In the upper left corner of FIG. 2 the housing of the CPR simulation manikin is illustrated. In a schematic manner the transmission of force between the housing of the CPR simulation manikin and the active actuator M is illustrated as a dashed line. A depression sensor DS performs a measurement of the instantaneous depression of the CPR simulation manikin's upper surface. A force sensor FS measures the force that is transmitted between active actuator and the CPR-administrating person. The depression or displacement measurement provided by depression sensor DS and the force measurement provided by force sensor FS are supplied to a reaction force calculator RFC. The details of a possible implementation of the reaction force calculator will be discussed in connection with FIG. 4. The reaction force calculator RFC provides a desired value for the reactive force of the active actuator. The desired value for the reactive force can be regarded as a set point value for the reactive force. The desired value of the reactive force is provided to a controller CTRL. Another input for the controller CTRL is provided by the force sensor FS. The controller CTRL determines a control signal for the active actuator based on the desired value for the reactive force (set point) provided by the reactive force calculator RFC and the value of the force currently measured by the force sensor FS. The controller CTRL could also receive and process a value from the depression sensor DS in a more elaborate implementation of the proposed CPR simulation load.

The control signal determined by the controller CTRL is transmitted to a servo amplifier AMP. The role of the servo amplifier AMP is to convert the low power control signal to an active actuator drive signal having sufficient power to drive the active actuator.

The CPR simulation load shown in FIG. 2 also shows the optional components for adjusting the reactive force during the duration of the CPR. To this end the output of the depression sensor DS is provided to a timer TMR and/or a counter CNT. Although not shown in FIG. 2, it is also possible to use the output of the force sensor FS, or of both sensors DS and FS. Upon the first stroke of the CPR administering person the start of a CPR-session is detected by the timer TMR and/or the counter CNT. The criterion for determining the start of a CPR-session could be that the depression depth and/or the force exceed a predetermined threshold. From medical studies covering CPR it is known that the mechanical properties of the chest of the patient vary during the course of the CPR. These variations have also been determined in a quantitative manner. The relations describing the variations of the mechanical properties of a patient's chest are stored in a memory MEM. An adjuster ADJ queries the memory MEM by sending the elapsed time and/or the stroke count since the start of the CPR session. The memory MEM responds by sending a parameter set describing the mechanical properties of a patient's chest after the elapsed time and/or stroke count. In a more elaborate implementation of the CPR simulation load the adjustor ADJ may also receive the values provided by the depression sensor DS and/or the force sensor FS. Under certain circumstances it is possible that an excessive depression depth and/or force causes damage to the patient's chest, such as broken rips. These damages lead to an enduring variation of the mechanical properties of the chest. The adjuster ADJ may observe the values and compare them with a threshold at which e.g. a broken rib would probably occur. The adjustor ADJ might also determine an average value of the depression depth and/or the force in order to deduct variations of the mechanical properties there from.

The measured values for the depression depth and the reactive force obtained from the depression sensor DS and the force FS sensor, respectively, may also be supplied to a user interface UIF. The user interface UIF interprets the measured values and compares them with the values suggested by official guidelines for cardiopulmonary resuscitation. The user interface may then output visual, audible or tactile advice to the person administering CPR. For example, the advice could be an audible speech output instructing the person to increase the stroke frequency or to increase the depression depth. The audible output could also be a periodical beep indicating the optimal rhythm for CPR. In the case of a visual output of the user interface UIF, the user interface may comprise a liquid crystal display, light emitting diodes (LEDs), light bulbs, analogue indicators, or the like to inform the person administering CPR or a trainer about the quality of the administered CPR.

FIG. 3 shows a perspective view of some of the main parts of a CPR simulation load according to the teachings disclosed herein. Already known from FIG. 1 are the electrical motor 112, the transmission 113, the pinion 114, and the rack 115. The transmission 113 is shown as a belt transmission comprising a first pulley 312, a belt 313, and a second pulley 314. The first and second pulleys 312, 314 could have different diameters in order to implement a certain gear ratio. Mounted to the electrical motor 112 is a servo amplifier 322 which drives the electrical motor in accordance with a control signal.

The torque produced by the DC rotary motor is transferred via the gear belt and corresponding pulley to a pinion-and-rack construction. The rotary movement of the electrical motor 112 is converted to a linear up-and-down movement by means of the pinion 114 and the rack 115. The rack 115 is mounted to a gliding block 333. The gliding block 333 is guided by a guide shaft 334 and a ball bearing 335 running in a grove formed in a rod 336. Thus, the motion is constrained by the ball bearing and the guide shaft. The gliding block 333 is also connected to two dampers 331, 332. The construction is mounted on a base plate 303 that provides sufficient stability and connects the CPR simulation load with a CPR simulation manikin. Mounted to the upper surface of the gliding block 333 is the force sensor FS over which the force exerted by the person administering CPR and the reactive force are transmitted. Low-cost mass production is possible when the non-standard metal parts are replaced by molded plastic parts. The CPR simulation load shown in FIG. 3 has been implemented. First tests of the device show good functionality. The present device can be switched between three modes: stiff, average and weak chest. For future devices, a broader selection of modes may be envisaged.

As to the mechanical construction, the complete device should fit in a limited volume (i.e. a CPR simulation manikin), the chest compression depth should be at least 6 cm, and reaction forces up to 1000 N are required. Further boundary conditions are low weight and low power consumption (battery supply should be possible). In one of the possible solutions, a rotary DC motor is used. To reduce the size of the motor, a combination of the motor with passive springs and/or dampers may be used. The motor delivers the additional braking or acceleration force needed to accurately model the required reaction force. As can be seen in FIG. 2, mostly standard components are used, with some parts manufactured for the specific design.

Turning now to FIG. 4, the control chain of the CPR simulation load is shown. The depression depth is determined by measuring the motor angel by means of a suitable sensor 401. The motor angle is then converted to the actual depression depth POS. X by means of a conversion block 402. The conversion block 402 may perform a simple multiplication of the motor angle with a constant factor and might be incorporated with the angle sensor 401 or the subsequent blocks. The angle sensor 401 and the conversion block 402 form the depression sensor DS known from FIG. 2.

The signal or value indicative of the depression depth is submitted to an elastic force computation block 403 and to a time derivative block 404. The elastic force computation block 403 calculates the portion of the reactive force that corresponds to the elastic constitution of the patient's chest. The calculation of the elastic force portion may be e.g. novel based, based on a formula, or look-up table based. Taking the example of a formula based approach, the elastic force portion of the reactive force may be represented as follows:

Fₑₗₐₛ=k(X)·x

Here x is the position at time t. The parameter k(x) is the position dependent elastic constant. Models for k(x) can be found in the literature, for example in Gruben et al. Journal of Biomech Eng., May 1993, vol 115, pp 14-20.

In a similar manner the viscous or damping portion of the reactive force is determined by means of time derivative block 404 and damping force computation block 405. Time derivative block 404 provides the time derivative of the position, i.e. the velocity. The damping force mainly depends on the velocity. Damping force computation block 405 may be for example model based, formula based, or look-up table based. If a formula based approach is used, the damping force can be expressed as

F_{damp}=μ(x)·v

Here v is the velocity at time t, F_{damp} is the viscose part of the reactive force and the parameter μ(x) is the position dependent damping constant. Again, models for μ(x) can be found in the literature. Typically polynomial fits up to fourth order in position suffice for k(x) and μ(x). The dashed box 406 indicates which part of the CPR simulation load is model based, formula based, or look-up table based, as the case may be.

The elastic part of the reactive force Fₑₗₐₛ and the damping part of the reactive force F_{damp} are added at adder 407. In the context of FIG. 4 it is seen that any inertial portion of the reactive force is negligible compared to the elastic portion and the damping portion of the reactive force. If the inertial portion of the reactive force is to be included in the calculation, another time derivative block could be connected to the output of time derivative block 404. An inertial force computation block connected to the output of the second time derivative block could than calculate the inertial portion of the reactive force based on a constant factor or a formula similar to the formulas for the elastic and damping portions of the reactive force. The output of adder 407 represents the value of reactive force that would be expected from an actual patient given the measured depression depth and the time derivative thereof.

The output of adder 407 is transmitted to a difference block 408. Another input for the difference block 408 is provided by the force sensor FS, which may be a strain gauge force sensor. The output of the difference block 408 is the difference between the applied force and the calculated reactive force, and can be regarded as an error signal. The error signal is supplied to a PID controller 409. A PID controller usually allows fast and accurate control of a control loop. The output of PID controller 409 is fed into the input of a servo amplifier 410 that provides a drive signal for the active actuator.

The active actuator (possibly in combination with a spring and/or a damper) delivers the required reactive force by minimizing the error signal of the PID controller. The sampling rate is suggested to be in the order of 100 Hz or higher.

The servo loop described above is based on equalizing the applied force and the calculated reactive force (i.e. the estimated reactive force based on the model). This requires three parameters in the loop, i.e. the applied force, the position and the velocity. The main control variable is force, but position is indirectly important as well as it determines the required reactive force.

FIG. 5 shows a flowchart for a method for simulating a reactive force of a patient's chest during cardiopulmonary resuscitation. Starting at action 501, the method proceeds to action 502 for measuring a depression of a simulation manikin chest. At action 503 a resulting reactive force depending on the measured depression of the simulation manikin chest is calculated. Action 504 corresponds to applying the resulting reactive force to the simulation manikin chest by means of an active actuator. The method ends at action 505. The method may contain additional actions or sub-actions that are part of one of the actions 502, 503, 504.

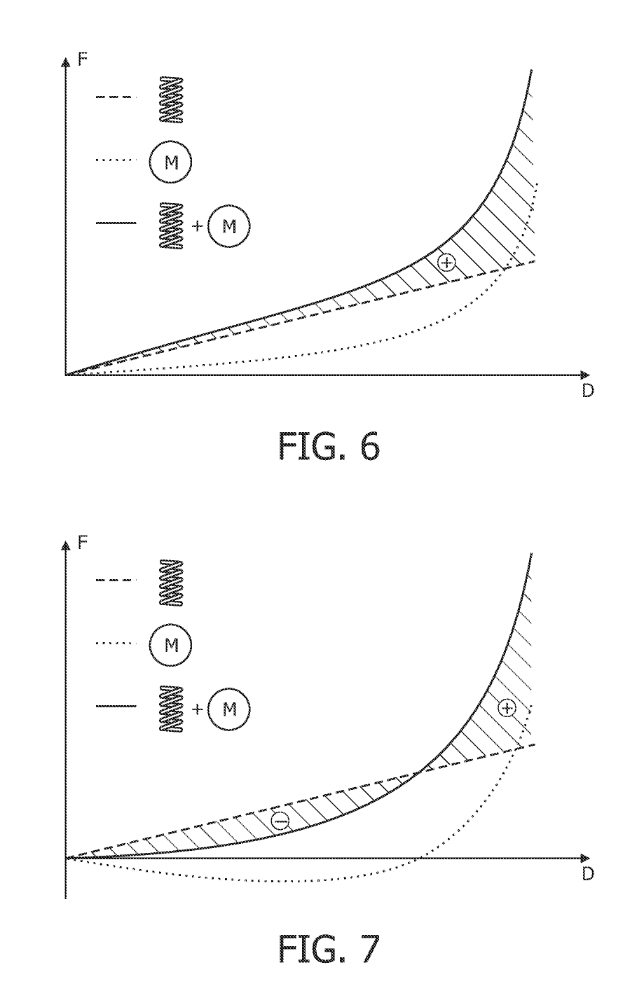

FIGS. 6 and 7 show two functional relations between the depression depth D and the reactive force F. As already mentioned in the context of FIGS. 1 and 3, the total reactive force is produced by adding the contributions of a spring and an active actuator. Note that this is true for the implementation of some embodiments of the teachings disclosed herein, only. It is indeed possible to provide an active actuator only, and omit the spring and the damper. In other implementations of the teachings disclosed herein it is also possible to provide an active actuator, a spring, and a damper. Turning back to FIG. 6, the linear force—displacement characteristic of a spring indicated by a dashed line. The force—displacement characteristic of the active actuator is non-linear and represented by a dotted line. The total reactive force is obtained by adding the spring force and the active actuator force. The total reactive force is represented in FIG. 6 as a full line. The hatched area between the spring force curve and the total reactive force curve corresponds to the contribution of the active actuator, that is the amount of force to be supplied by the active actuator in order to reach the desired total reactive force.

FIG. 7 is similar to FIG. 6 with the exception that the force contributed by the active actuator may assume negative value for some values of the depression depth. In FIG. 7 this is true for small values of the depression depth D. In this range of the graph the active actuator is actually assisting the person administering CPR to counteract the reactive force of the spring. With increasing depression depth, the desired total reactive force increases rapidly and so does the contribution of the active actuator. The hatched area between the spring force curve and the total reactive force curve now has two sections, a first section referenced by a minus sign in which the contribution of the active actuator is negative, and a second section referenced by a plus sign, in which the contribution of the active actuator is positive. Switching from negative to positive contribution of the active actuator may be achieved by performing a pole change on a DC motor.

While the invention has been illustrated and described in detail in the drawings and the forgoing description, such illustration and description are to be considered illustrative or exemplary and not restrictive; the invention is not limited to the disclosed embodiment. For example, it is possible to employ transmission mechanisms different form the pulley-belt construction or the pinion-and-rack mechanism. The electric motor may also be an AC motor, a torque motor, or a linear motor. Instead of an electrical motor, the active actuator may employ a pneumatic or hydraulic element. Other types of controller than a PID controller may be used, for example a proportional controller, a PI controller, or a state space controller. Some parts of the teachings disclosed herein may be implemented in software, in particular the controller CTRL, the reaction force calculator RFC and the adjuster ADJ. Nevertheless, it is also possible to implement these and other elements of the CPR simulation load by means of hardware. Control parameters can be force, displacement, a combination of these, or another suitable parameter, such as pressure, acceleration etc. The control can be done using a PC with interface hardware or by a dedicated control hardware. The simulation load and the simulation manikin according to the teachings disclosed herein are also suitable for patient simulators with ALS function.

The invention can be used in applications where people are trained to administer CPR in an efficient and safe manner. The invention can also be used for testing, tuning and calibrating automated CPR equipment.

Other variations to the disclosed embodiment can be understood and effected by those skilled in the art in practicing the claimed invention, from study of the drawings, the disclosure, and the appended claims. In the claims, the word “comprising” does not exclude other elements or steps, and the indefinite article “a” or “an” does not exclude a plurality. A single processor or other unit may perform functions of several items recited in the claims, and vice versa. The mere fact that certain measures are recited in mutually different dependent claims does not indicate that combination of these measures cannot be used to advantage. A computer program may be stored/distributed on a suitable medium, such as an optical storage medium or a solid-state medium supplied together with or as part of other hardware, but may also be distributed in other forms, such as via the Internet other wire or wireless telecommunication systems. Any reference found in the claims should not be construed as limiting the scope.

1. Cardiopulmonary resuscitation simulation load capable of simulating a reactive force of a patient's chest upon chest depression, the cardiopulmonary resuscitation simulation load comprising an active actuator arranged to generate at least part of the reactive force, and a controller arranged to provide a control signal to the active actuator.

2. Cardiopulmonary resuscitation simulation load according to claim 1, wherein the active actuator is an electromechanical actuator, a pneumatic actuator, or a hydraulic actuator.

3. Cardiopulmonary resuscitation simulation load according to claim 1, further comprising a passive mechanical component arranged to generate a remainder of the reactive force.

4. Cardiopulmonary resuscitation simulation load according to claim 1, further comprising a chest depression sensor arranged to provide a chest depression measurement to the controller.

5. Cardiopulmonary resuscitation simulation load according to claim 4, further comprising a reaction force calculator arranged to calculate said part of the reactive force generated by the active actuator as a function of the chest depression measurement.

6. Cardiopulmonary resuscitation simulation load according to claim 5, wherein said reaction force calculator is model based or based on an empirical relation.

7. Cardiopulmonary resuscitation simulation load according to claim 5, wherein the reaction force calculator contains at least one of an elastic term, a damping term, or an inertial term.

8. Cardiopulmonary resuscitation simulation load according to claim 5, wherein the reaction force calculator is software controlled.

9. Cardiopulmonary resuscitation simulation load according to claim 1, wherein the active actuator is a DC rotation motor.

10. Cardiopulmonary resuscitation simulation load according to claim 9, further comprising a pinion and rack construction arranged to convert a rotary movement of the DC rotation motor into a linear movement of the chest.

11. Cardiopulmonary resuscitation simulation load according to claim 1, further comprising a force sensor arranged to provide a force measurement to the controller for providing servo control for the active actuator based on a force control loop.

12. Cardiopulmonary resuscitation simulation load according to claim 1, further comprising a feedback interface for providing feedback to a user.

13. (canceled)

14. Method for simulating a reactive force of a patient's chest during cardiopulmonary resuscitation by means of a simulation manikin, the method comprising:
measuring a depression of a simulation manikin chest;
calculating a resulting reactive force depending on the measured depression of the simulation manikin chest; and
applying the resulting reactive force to the patient's chest by means of an active actuator.
